(19) United States
(12) Patent Application Publication
(10) Pub. No.: US 2021/0362281 A1
(43) Pub. Date: Nov. 25, 2021

(54) Unloader/Pusher Tube Debris Removal System

(71) Applicant: Atkinson International, Inc., Gastonia, NC (US)

(72) Inventor: Darin Atkinson, Clover, SC (US)

(21) Appl. No.: 16/879,275

(22) Filed: May 20, 2020

(51) Int. Cl. B23Q 11/00; B23Q 7/00; B23B 13/12; B23B 13/02

(52) U.S. Cl. CPC B23Q 11/005; B23B 13/02; B23B 13/12; B23Q 7/006

(57) ABSTRACT

A CNC unloader includes an unloader pusher/tube for unloading a part from a CNC machine. A collet couples with the unloader pusher/tube for gripping the part. A debris remover is coupled with the unloader pusher/tube. The debris remover exits fluid from the collet, to remove metal chips or the like from the part and sub spindle, to enable a clean gripping with the part.

### FIELD

The present disclosure relates to CNC machines, such as lathes, that include an unloader with an unloader pusher/tube that includes a debris removal system.

### BACKGROUND

In current CNC machines, metal chips and debris accumulate during the cutting of parts. In order to remove the parts from the CNC machine, the finished part must be clear of debris so that the unloader pusher/tube can grasp the part and remove it from the CNC spindle. The unloader pusher/tube must go through a sub spindle in the CNC machine and grab the finished part to remove it from the CNC machine. If the metal chips or debris are in the way, the unloader collet is unable to grab and unload the part. Thus, this causes a jam or stop of the unloader and the CNC machine by erroring out and stopping the CNC machine. This causes manual removal of the debris.

Thus, it is desirable to have a system that removes the debris. It is preferred that the system be associated with unloader pusher/tube and collet so that the debris can be removed while the unloader pusher/tube and collet continue to grasp the finished part. The present disclosure provides an unloader with an unloader pusher/tube that removes debris as it enters the CNC machine sub spindle. The present disclosure provides for a simple design that provides an air blast to exit debris from the finished part. The air blast can be readily controlled by the CNC machine through output signals in conjunction with control of a solenoid valve.

### SUMMARY

Accordingly to a first aspect of the disclosure, the CNC unloader comprises an unloader pusher/tube for unloading a part from a CNC machine. A collet is coupled with the unloader pusher/tube for gripping the part. The debris remover is coupled with the unloader pusher/tube. The debris remover exits fluid from the collet to enable a clean gripping of the part. The debris remover further comprises an outlet in the collet. The outlet is coupled with a compressed air supply. A pipe is in the unloader pusher/tube and forms the debris remover to supply the compressed air supply to the debris remover. A retractor is coupled with the hose to keep the hose taunt as the unloader pusher/tube moves in the unloader. A controller controls the exiting of the fluid from the debris remover.

According to a second aspect of the disclosure, a CNC machine unloader comprises an unloading gravity chute, an unloader pusher/tube housing and an unloader pusher/tube. The unloader pusher/tube further comprises a collet coupled with the unloader pusher/tube for gripping the part. The debris remover is coupled with the unloader pusher/tube. The debris remover exits fluid from the collet to enable a clean gripping of the part. The debris remover further comprises an outlet in the collet. The outlet is coupled with a compressed air supply. A pipe is in the unloader pusher/tube and forms the debris remover to supply the compressed air supply to the debris remover. A retractor is coupled with the hose to keep the hose taunt as the unloader pusher/tube moves in the unloader. A controller controls the exiting of the fluid from the debris remover.

According to a third aspect of the disclosure, a CNC machine in combination with a parts unloader comprises a CNC machine, an unloader comprises an unloading gravity chute, an unloader pusher/tube housing and an unloader pusher/tube. The unloader pusher/tube further comprises a collet coupled with the unloader pusher/tube for gripping the part. The debris remover is coupled with the unloader pusher/tube. The debris remover exits fluid from the collet to enable a clean gripping of the part. The debris remover further comprises an outlet in the collet. The outlet is coupled with a compressed air supply. A pipe is in the unloader pusher/tube and forms the debris remover to supply the compressed air supply to the debris remover. A retractor is coupled with the hose to keep the hose taunt as the unloader pusher/tube moves in the unloader. A controller controls the exiting of the fluid from the debris remover.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a CNC machine with an unloader.

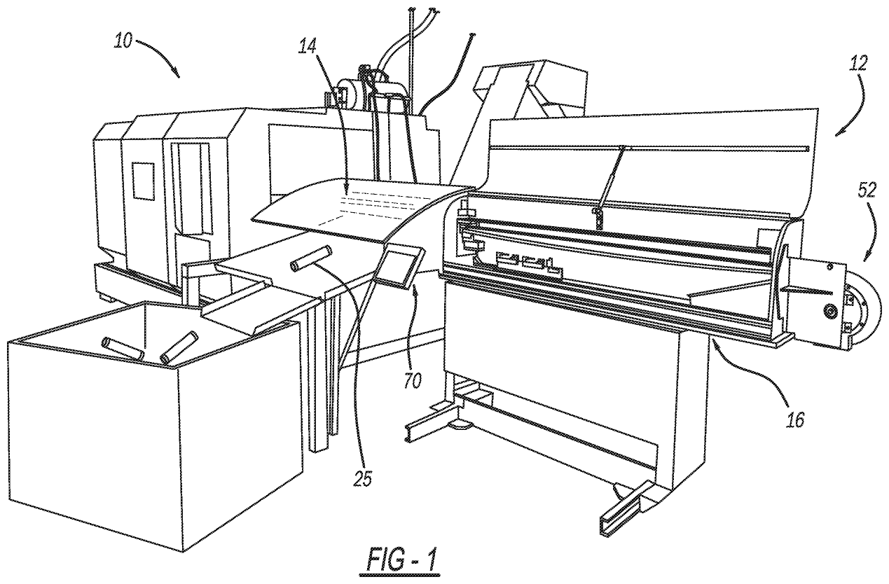

FIG. 2 is an enlarged perspective view of an unloader pusher/tube.

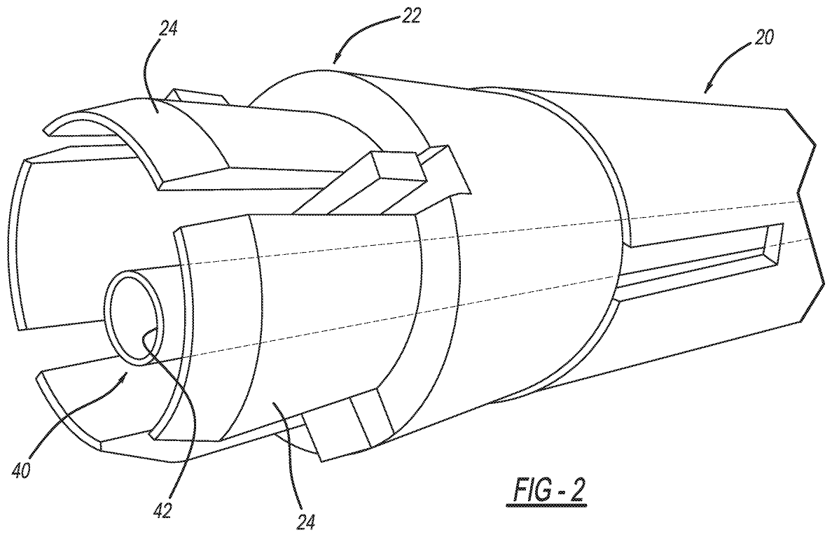

FIG. 3 is an exploded view of the unloader pusher/tube.

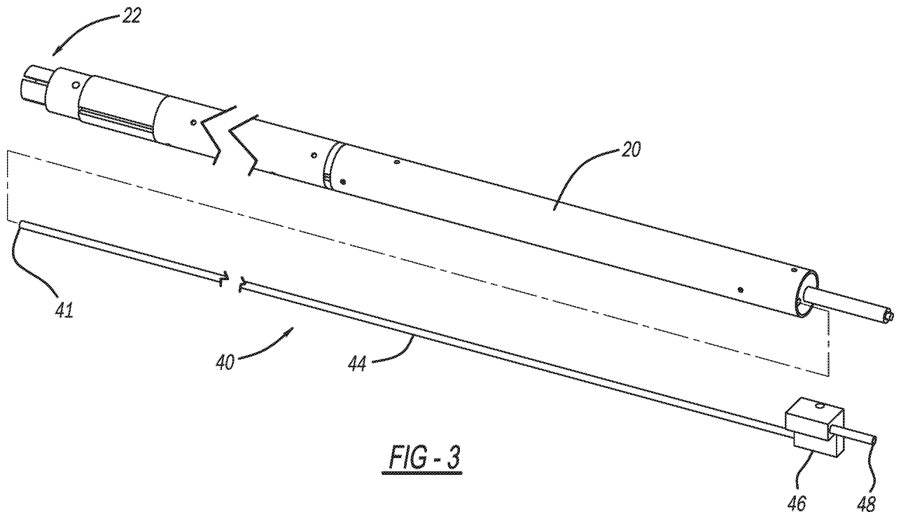

FIG. 4 is a perspective view of the hose retractor.

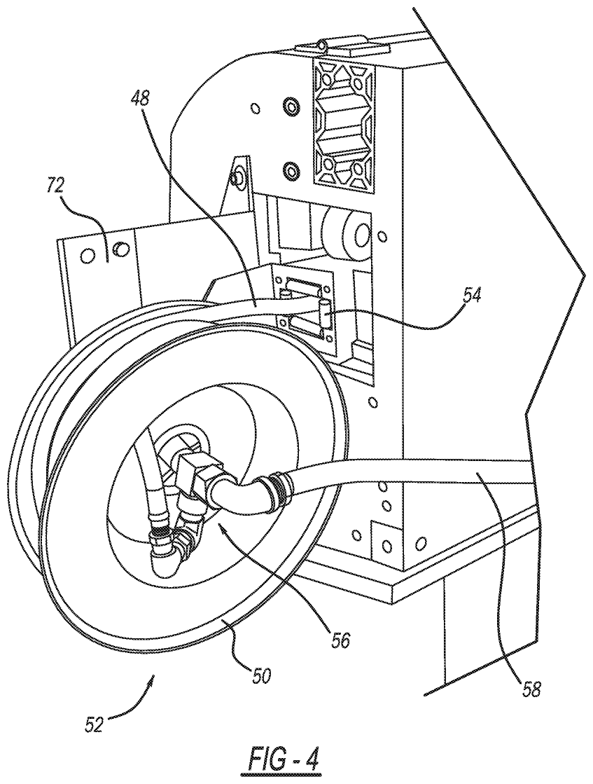

FIG. 5 is a rear perspective view of the unloader.

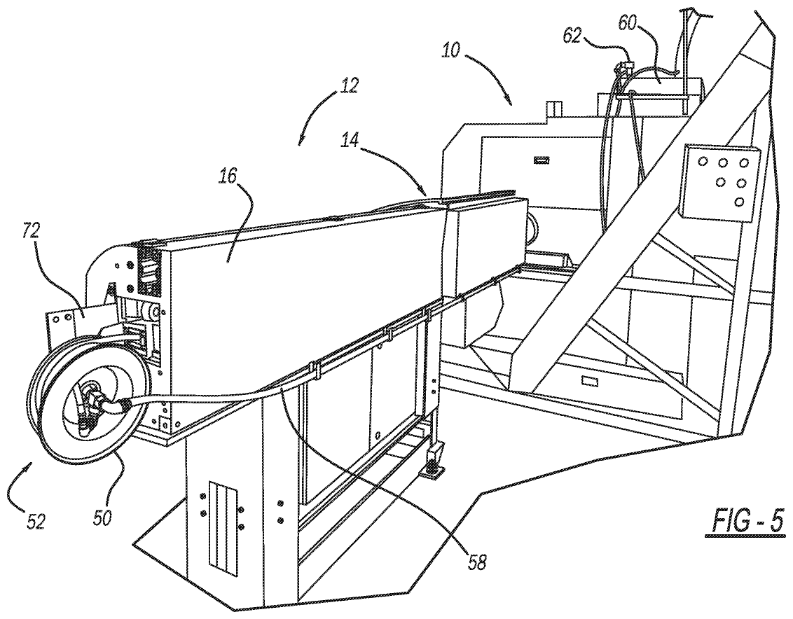

FIG. 6 is a schematic view of the system.

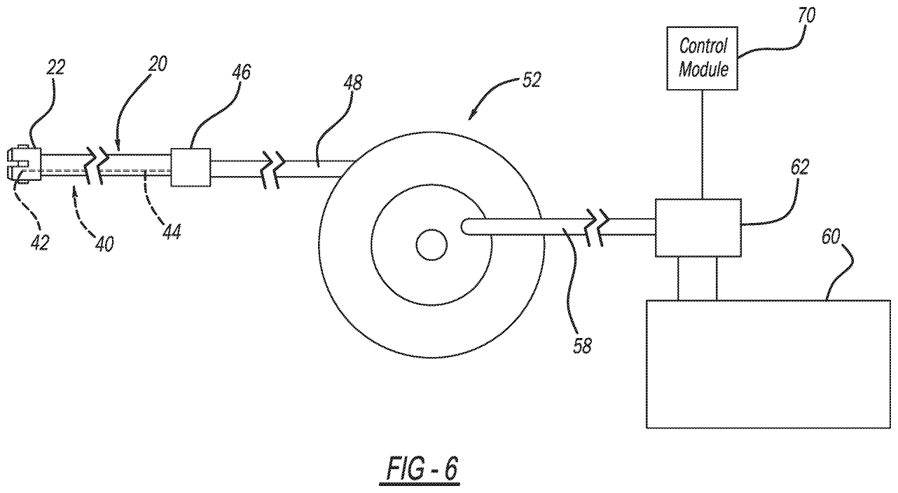

### DETAILED DESCRIPTION

Turning to the figures, a CNC machine 10 is shown coupled with an unloader 12. The CNC machine 10 may be a lathe or the like. The unloader 12 includes an unloader gravity chute 14 and unloader pusher/tube housing 16. An unloader pusher/tube 20 is positioned in the unloader pusher/tube housing 16. The unloader pusher/tube 20 includes a collet 22.

The unloader pusher/tube 20 moves along its axis in the housing 16 through the unloader gravity chute 14 and inserts the collet 22 into a sub spindle in the CNC machine 10. The collet 22 removes the finished part 25 from the sub spindle. As the collect 22 exits the sub spindle, due to the return axial movement of the unloader pusher/tube 20, the finished part 25 is deposited on the unloader gravity chute 14.

The unloader pusher/tube 20 is generally a hollow cylinder with the collet 22 at one end. The collet 22 generally has a plurality of fingers 24 to grip, either internally or externally, the finished part 25. The fingers 24 move in and out to grasp the part 25. A debris removal system 40 is coupled with the unloader pusher/tube 20. The debris removal system 40 includes an outlet 42, a delivery pipe 44, a manifold 46 with a flexible hose 48. The pipe 44 extends through the unloader pusher/tube 20. The manifold 46 is attached to the pipe 44 at the other end 20 of the unloader pusher/tube.

The flexible hose 48 is coupled with the manifold 46. The hose 48 is wrapped around a wheel 50 of the retractor 52. The wheel 50 is secured to a bracket 72 on the unloader 12. The bracket 72 maintains the wheel 50 in position. The wheel 50 is spring biased to hold the hose 48 taunt as it moves with the unloader pusher/tube 20 in the housing 16. Thus, as the unloader pusher/tube 20 moves axially in and out, the hose 48 remains taunt as it is held by the take up 54. The hose 48 is coupled with an air tank 60 via plumbing 56. A hose 58 from the air tank 60 is coupled with the plumbing 56 on the wheel 50.

A solenoid valve 62 is positioned on the air tank 60. The solenoid valve 62 is electronically coupled with a controller 70 of the CNC machine 10. The controller 70, via sending an output signal, enables air to exit the air tank 60, via valve 62, through the hose 58 and into the pipe 44 out the outlet 42 at the collet 22. The controller 70, coupled with the CNC machine, sends an output signal to the valve 62 to deliver the burst of air to the outlet 42. The burst of air keeps the sub spindle free of chips and debris. It also keeps the parts 25 free of metal chips as it blows while the unloader is coming into contact with the finished part 25. This enables the finished parts to be removed successfully and quickly from the CNC machine 10.

The outlet 42 is at the end of the delivery tube or pipe 44. The delivery tube 44 is generally comprised of a metallic material. The delivery tube outlet inlet 42 may or may not include a jet to enhance fluid exit from the outlet 42. The metallic pipe 44, generally copper, is passed entirely through the unloader pusher/tube 20. The flexible hose 48 is, in turn, coupled with the manifold 46 at the end of the delivery tube 44. Thus, air can pass from the tank 60 through the hose 58, plumbing 56, hose 48, pipe 44 and eventually out the outlet 42. The delivery pipe 44 is maintained in the hollow unloader pusher/tube 20 and collet 22 so that upon activation, the air blasts exit the outlet 42 and removes the debris or chips from the finished part 25 and sub spindle.

In operation, the unloader pusher/tube 20 is moved in the unloader housing 16 toward the CNC machine 10. As this occurs and the collet 22 is in position to grab a finished part 25, as this occurs, the controller 70 sends a signal to the solenoid valve 62 opening it. This enables air in the tank 60 to move through the valve 62, hose 58, plumbing 56, hose 48 to the manifold 46. The manifold 46 directs the blast of air into the delivery pipe 44 to the outlet 42. As this occurs, the fluid exits the outlet 42 toward the part 25 and sub spindle. The air blows chips and debris away from the finished part 25, to enable the finished part 25 to be free from debris. Thus, the collet fingers 24 grab the finished part 25 and pull it through the sub spindle. As the finished part 25 reaches the unloading gravity chute 14, the mandrel collet 22 releases the part and readies for another cycle

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A CNC unloader pusher comprising:
an unloader pusher for unloading a part from a CNC machine;
a collet coupled with the unloader pusher for gripping the part; and
a debris remover coupled with the unloader pusher, the debris remover exiting fluid from the collet for enabling a clean gripping with the part.

2. The unloader pusher according to claim 1, wherein the debris remover further comprises an outlet in the collet.

3. The unloader pusher according to claim 2, wherein the outlet is coupled with a compressed air supply.

4. The unloader pusher according to claim 1, wherein a delivery pipe is in the unloader pusher and forms the debris remover for supplying a compressed air supply to the debris remover.

5. The unloader pusher according to claim 4, further comprising a retractor coupled with a flexible hose for keeping the flexible hose taunt as the flexible house moves with the unloader pusher in the unloader.

6. The unloader pusher according to claim 1, further comprising a controller for controlling exiting of the fluid from the debris remover.

7. A CNC machine unloader comprising:
an unloading gravity chute;
an unloader housing; and
an unloader pusher, the unloader pusher further comprising:
a collet coupled with the unloader pusher for gripping the part; and
a debris remover coupled with the unloader pusher, the debris remover exiting fluid from the collet for enabling a clean gripping with the part.

8. The machine unloader according to claim 7 wherein the debris remover further comprises an outlet in the collet.

9. The machine unloader according to claim 8, wherein the outlet is coupled with a compressed air supply.

10. the machine unloader according to claim 7, wherein a delivery pipe in the unloader pusher forms the debris remover for supplying a compressed air supply to the debris remover.

11. The machine unloader according to claim 10, further comprising a retractor coupled with a flexible hose for keeping the flexible hose taunt as the flexible hose moves with the unloader pusher in the unloader.

12. The machine unloader according to claim 7, further comprising a controller for controlling exiting of the fluid from the debris remover.

13. A CNC machine in combination with a parts unloader comprising:
a CNC machine;
a parts unloader including an unloading gravity chute, an unloader housing, and an unloader pusher, the unloader pusher further comprising:
a collet coupled with the unloader pusher for gripping a part; and
a debris remover coupled with the unloader pusher, the debris remover exiting fluid from the collet for enabling a clean gripping with the part.

14. The CNC machine in combination with a parts unloader according to claim 13, wherein the debris remover further comprises an outlet in the collet.

15. The CNC machine in combination with a parts unloader according to claim 14, wherein the outlet is coupled with a compressed air supply.

16. The CNC machine in combination with a parts unloader according to claim 13, wherein a delivery pipe is in the unloader pusher and forms the debris remover for supplying a compressed air supply to the debris remover.

17. The CNC machine in combination with a parts unloader according to claim 16, further comprising a retractor coupled with a flexible hose for keeping the flexible hose taunt as the flexible hose moves with the unloader pusher in the unloader.

18. The CNC machine in combination with a parts unloader according to claim 13, further comprising a controller for controlling exiting of the fluid from the debris remover.
